(19) United States
(12) Patent Application Publication
(10) Pub. No.: US 2022/0382925 A1
(43) Pub. Date: Dec. 1, 2022

(54) METHOD AND SYSTEM FOR DESIGNING AND PURCHASING A BUILDING

(71) Applicant: Allied Steel Buildings Inc., Fort Lauderdale, FL (US)

(72) Inventors: Michael Lassner, Boca Raton, FL (US); Deven Blackburn, Fort Lauderdale, FL (US)

(21) Appl. No.: 17/335,495

(22) Filed: Jun. 1, 2021

(51) Int. Cl. G06F 30/12; G06F 30/17; G06F 30/13; G06Q 30/02

(52) U.S. Cl. CPC G06F 30/12; G06F 30/17; G06F 30/13; G06Q 30/0284

(57) ABSTRACT

A computer-implemented method that includes generating design load values for a geographical location in response to receiving the geographical location via user identification or entry into a Graphical User Interface (GUI) displayed on a user device. The design load values include a wind speed value, a snow load value, and/or a seismic value. The method includes determining option content to include in a building design option menu to be rendered on the GUI displayed on the user device. The building design option menu includes information fields for each one of one or more building dimension options for a Three-Dimensional (3D) building model and for each one of one or more building accessory options for the 3D building model. The option content includes the one or more building dimension options and/or the one or more building accessory options that meet or exceed the design load values. The method includes determining, in response to receiving selected building dimensions and/or selected building accessories that are identified or entered by the user into the information fields, a price of building materials for the 3D building model that has been modified to include the selected building dimensions and/or the selected building accessories. The method includes causing, in response to the generating of the price of the building materials, the GUI displayed on the user device to indicate the price of the building materials and to render a view of the 3D building model that has been modified to include the selected building dimensions and/or the selected building accessories.

### FIELD OF TECHNOLOGY

The present invention relates to an interactive building design technology, and more specifically, to an interactive building design and purchasing system for a prefabricated building.

### BACKGROUND

Metal buildings are becoming increasing popular due to their ease of construction and the ability to use these types of buildings for industrial buildings, commercial and retail buildings and residential housing. When a building is planned for a specific location and use, there are requirements that the building must meet such as design load requirements. The design load requirements are site-specific and impact how the building is designed and the cost of the parts and accessories used for the building. For example, a wind speed design load limit specifies a maximum wind speed, a snow design load limit specifies a maximum weight, and a seismic design load limit specifies a maximum amount of ground acceleration that the building, including any accessories such as doors and windows, must be able to withstand. As a result, designing and purchasing a metal building can be time consuming as retailers that sell metal buildings must first determine the parts and accessories needed for the building to meet the design load limits before a price can be quoted to a customer.

For these and other reasons, there is a need for the present invention.

### SUMMARY

According to an embodiment of a computer-implemented method, the method includes generating building design load values for a geographical location in response to receiving the geographical location from the user device. The geographical location is identified or entered by the user via a Graphical User Interface (GUI) displayed on a user device. The building design load values include a wind speed value, a snow load value, and/or a seismic value. The method includes determining option content to include in a building design option menu to be rendered on the GUI displayed on the user device. The building design option menu includes information fields for each one of one or more building dimension options for a Three-Dimensional (3D) building model and for each one of one or more building accessory options for the 3D building model. The option content includes the one or more building dimension options and/or the one or more building accessory options that meet or exceed the design load values. The method includes determining, in response to receiving selected building dimensions that are identified or entered by the user into the information fields for at least one of the one or more building dimension options via the GUI displayed on the user device and/or in response to receiving selected building accessories that are identified or entered by the user into the information fields for at least one of the one or more building accessory options via the GUI displayed on the user device, a price of building materials for the 3D building model that has been modified to include the selected building dimensions and/or the selected building accessories. The method includes causing, in response to the generating of the price of the building materials, the GUI displayed on the user device to indicate the price of the building materials and to render a view of the 3D building model that has been modified to include the selected building dimensions and/or the selected building accessories.

According to an embodiment of a computer program product, the computer program product is embodied in a computer-readable storage device. The computer program product includes instructions that when executed by one or more processors, cause the one or more processors to generate building design load values for a geographical location in response to receiving the geographical location from a user device. The geographical location is input by the user via user identification or entry into a Graphical User Interface (GUI) displayed on a user device. The building design load values include a wind speed value, a snow load value, and/or a seismic value. The instructions, when executed by the one or more processors, further cause the one or more processors to determine option content to include in a building design option menu to be rendered on the GUI displayed on the user device. The building design option menu includes information fields for each one of one or more building dimension options for a Three-Dimensional (3D) building model and for each one of one or more building accessory options for the 3D building model. The option content includes the one or more building dimension options and/or the one or more building accessory options that meet or exceed the design load values. The instructions, when executed by the one or more processors, further cause the one or more processors to determine, in response to receiving selected building dimensions that are identified or entered by the user into the information fields for at least one of the one or more building dimension options via the GUI displayed on the user device and/or in response to receiving selected building accessories that are identified or entered by the user into the information fields for at least one of the one or more building accessory options via the GUI displayed on the user device, a price of building materials for the 3D building model that has been modified to include the selected building dimensions and/or the selected building accessories. The instructions, when executed by the one or more processors, further cause the one or more processors to cause, in response to the generating of the price of the building materials, the GUI displayed on the user device to indicate the price of the building materials and to render a view of the 3D building model that has been modified to include the selected building dimensions and/or the selected building accessories.

According to an embodiment of a system, the system includes one or more processors and one or more memory elements. The one or more memory elements store program instructions that when executed by the one or more processors, cause the one or more processors to generate building design load values for a geographical location in response to receiving the geographical location from a user device. The geographical location is identified or entered by the user via a Graphical User Interface (GUI) displayed on a user device. The building design load values include a wind speed value, a snow load value, and/or a seismic value. The program instructions, when executed by the one or more processors, further cause the one or more processors to determine option content to include in a building design option menu to be rendered on the GUI displayed on the user device. The building design option menu includes information fields for each one of one or more building dimension options for a Three-Dimensional (3D) building model and for each one of one or more building accessory options for the 3D building model. The option content includes the one or more building dimension options and/or the one or more building accessory options that meet or exceed the design load values. The program instructions, when executed by the one or more processors, further cause the one or more processors to determine, in response to receiving selected building dimensions that are identified or entered by the user into the information fields for at least one of the one or more building dimension options via the GUI displayed on the user device and/or in response to receiving selected building accessories that are identified or entered by the user into the information fields for at least one of the one or more building accessory options via the GUI displayed on the user device, a price of building materials for the 3D building model that has been modified to include the selected building dimensions and/or the selected building accessories. The program instructions, when executed by the one or more processors, further cause the one or more processors to cause, in response to the generating of the price of the building materials, the GUI displayed on the user device to indicate the price of the building materials and to render a view of the 3D building model that has been modified to include the selected building dimensions and/or the selected building accessories.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a diagram of an embodiment of an environment for a building design and purchase system.

FIG. 2 illustrates a diagram of an alternative embodiment of an environment for a building design and purchase system.

FIG. 3 illustrates a process diagram of an embodiment of rendering a view of a 3D building model, generating and rendering a price for building materials for the 3D building model and rendering a building design option menu on a GUI displayed on a user device for a geographical location entered by a user.

FIG. 4 illustrates a diagram of an embodiment of rendering a view of a 3D building model, generating and rendering a price for building materials for the 3D building model and rendering a building design option menu on a GUI displayed on a user device for building dimensions and/or building accessories selected by a user.

FIG. 5 illustrates a diagram of an embodiment of processing a payment request for payment of the price of building materials for a 3D building model that includes building dimensions and/or building accessories selected by a user.

FIG. 6 illustrates an embodiment of types of building design loads.

FIG. 7 illustrates an embodiment of building design load values and geographical data generated in response to receiving a geographical location from a user device.

FIG. 8 illustrates an embodiment of alert message options, building accessory options and building dimension options.

FIG. 9 illustrates an embodiment of a building design option menu rendered on a GUI displayed on a user device that includes alert message options, building accessory options and building dimension options illustrated in FIG. 8 that meet the building design load values and geographical data illustrated in FIG. 7.

FIG. 10 illustrates an embodiment of a GUI displayed on a user device that includes a price of building materials, a view of a building design option menu and a view of a 3D building model that has been modified to include selected building dimensions and/or selected building accessories.

FIG. 11 illustrates an embodiment of a building design option menu rendered on a GUI displayed on a user device.

FIG. 12 illustrates an embodiment of a building design option menu rendered on a GUI displayed on a user device.

FIG. 13 illustrates an embodiment of a building design option menu rendered on a GUI displayed on a user device.

FIG. 14 illustrates an embodiment of a building design option menu rendered on a GUI displayed on a user device.

FIG. 15 illustrates a flowchart of an embodiment of a method of generating a building design option menu with building dimension options and/or building accessory options and alert messages rendered on a GUI of a user device that are compliant with design load values for a geographical location.

### DETAILED DESCRIPTION

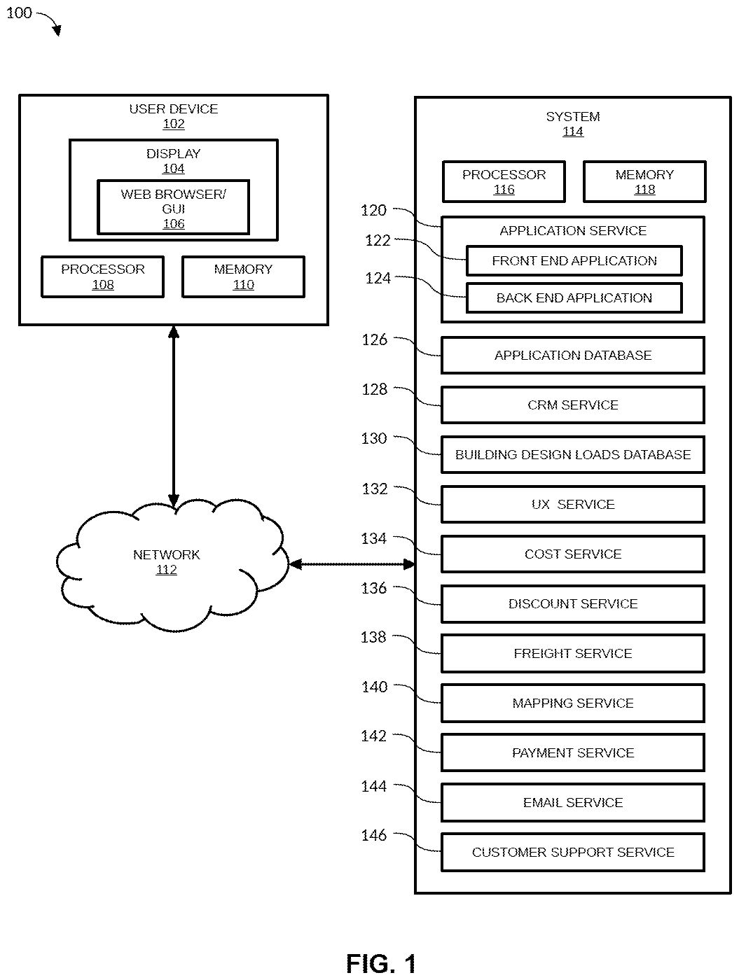

FIG. 1 illustrates a diagram at 100 of an embodiment of an environment for a building design and purchase system. A user device is illustrated at 102 and includes one or more processors illustrated at 108 and one or more memories or memory elements illustrated at 110. In various embodiments, user device 102 can be any suitable kind of data processing device such as a desktop computer, a laptop computer, a tablet, a mobile or cellular phone, a personal digital assistant or similar device capable of accessing the World Wide Web.

In the illustrated embodiment, a web browser 106 is utilized to render content from front end application 122 as a Graphical User Interface (GUI) on a display 104 of user device 102. As described herein, web browser/GUI 106 provides a web-based GUI interface that enables interaction between a user via user device 102 and the applications and services illustrated at 120-146. Web browser/GUI 106 provides a means for a user to identify or enter information into web browser/GUI 106 to interact with system 114. Web browser/GUI 106 provides a user interface that can be presented as one or more web pages. In other embodiments, any suitable GUI, whether web-based or not, can be used. In the illustrated embodiment, user device 102 is connected to system 114 via a network 112. In various embodiments, network 112 can include any suitable type of computer network that includes, but is not limited to, an internet connection, a cloud-based connection, a Local Area Network (LAN), a Metropolitan Area Network (MAN) or a Wide Area Network (WAN). In other embodiments, any suitable number of user devices such as user device 102 can be connected to system 114 via one or two or more networks such as network 112.

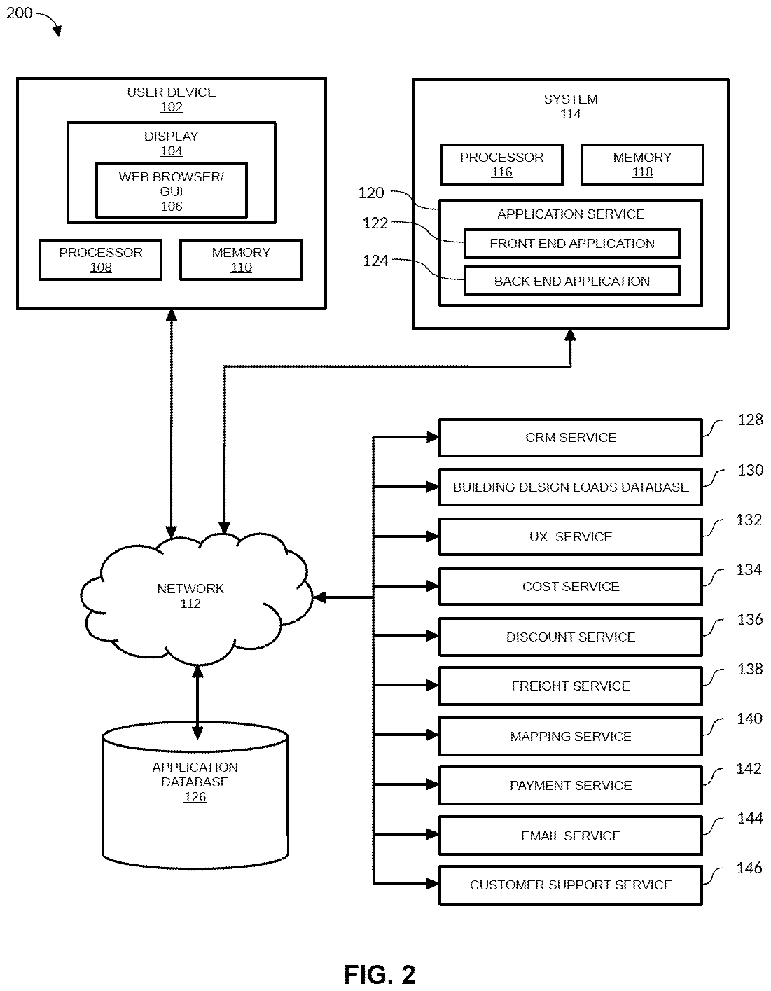

In the illustrated embodiment, system 114 includes one or more processors illustrated at 116 and one or more memories or memory elements illustrated at 118. System 114 can include or be hosted on one or more cloud servers 114 or one or more cloud-based platforms 114. As such, the applications and services illustrated at 120-146 can be hosted on a single cloud server or cloud-based platform, or on multiple cloud servers or cloud-based platforms. In the embodiments illustrated herein, the one or more processors 116 can be utilized to perform the functions and methods described herein. In some embodiments, one or more memory elements 118 store program instructions that when executed by the one or more processors 116 cause the one or more processors 116 to perform the functions and methods described herein. In some embodiments, the one or more memory elements 118 are located within a cloud-based application service or system 114 (see also, FIG. 2). In other embodiments, one or more memory elements 110 on user device 102 store program instructions that when executed by the one or more processors 108 cause the one or more processors 108 to perform the functions and methods described herein. In other embodiments, a computer program product is embodied in a computer-readable storage device and includes instructions that when executed by the one or more processors 108 or 116, cause the one or more processors 108 or 116 to perform the functions and methods described herein. The computer-readable storage device can include the one or more memories 110, the one or more memories 118, or any other suitable computer-readable storage device. These functions and services include, but are not limited to, application service 120 which includes front end application 122 and back end application 124, application database 126, Customer Resource Management (CRM) service 128, building design loads database 130, Universal Interface (UX) service 132, cost service 134, discount service 136, freight service 138, mapping service 140, payment service 142, email service 144 and customer support service 146.

In the illustrated embodiment, application service 120 includes a front end application 122 and a back end application 124. The front end application 122 is a building constructor and is responsible for rendering content on the GUI 106 displayed on the user device 102. The content rendered includes, but is not limited to, items such as a building design option menu, alert messages, a view of a Three-Dimensional (3D) building model and a price of building materials for the 3D building model. The content rendered may be based upon data provided by the user and the user's interaction with front end application 122 via GUI 106.

In the illustrated embodiment, front end application 122 is the front end software layer of application service 120 and comprises software that is written with a mix of EcmaScript and ClojureScript, and utilizes open source libraries that include React.js, Three.js, GraphQL, and Material UI, as well as re-frame, kee-frame, and pipe.dream libraries for state management. In other embodiments, front end application 122 can comprise any other suitable software languages or combination of suitable software languages. Back end application 124 is a data access software layer of application service 120 and triggers or initiates service applications that include CRM service 128, UX service 132, cost service 134, discount service 136, freight service 138, payment service 142 and email service 144. Back end application 124 validates, sanitizes, posts, and sends and retrieves data to and from the application database 126 and the building design loads database 130. Back end application 124 also passes data to and from the front end application 122. Back end application 124 is written primarily in an open-source software language Elixir, using a Phoenix web framework and Heroku. Heroku is a cloud Platform as a Service (PaaS) and is used for running and scaling web applications.

In the illustrated embodiment, user data is stored in and accessed from application database 126. The user data may be stored in and accessed from one or more user records. Application database 126 is a Postgres database which is an open-source and relational database served via the cloud platform Heroku. Queries to application database 126 are made using Structured Query Language (SQL).

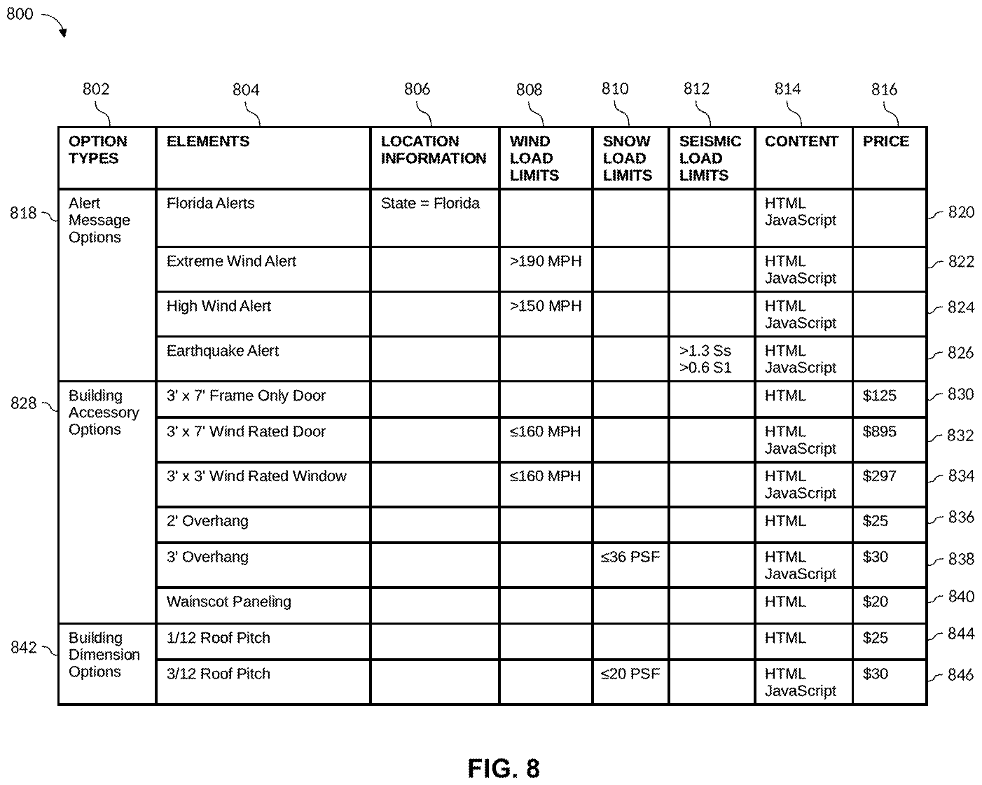

In the illustrated embodiment, application database 126 stores alert message options, building accessory options and building dimension options for the 3D building model as well as corresponding building design load limits, if any, for each alert message option, building accessory option and/or building dimension option. Application database 126 can also store content or references to content in the form of Hyper Text Markup Language (HTML) or JavaScript for the alert message options, building accessory options and building dimension options. The HTML content provides universal interface or text which is rendered or printed on the web browser/GUI 106 of user device 102. The JavaScript content is utilized to enact a change or action as required. The JavaScript content can be interpreted by the web browser/GUI 106. Application database 126 is further discussed with respect to FIG. 8.

In the illustrated embodiment, CRM service 128 is used for customer relationship management. All customer actions and customer data is passed to CRM service 128. CRM service 128 handles or manages data received from back end application 124 and a third-party CRM platform which is Zoho. In other embodiments, other suitable CRM platforms can be used. In the illustrated embodiment, CRM service 128 performs four functions which are carried out in the following order: validate, lookup, update, and create. The four functions can be performed via HTTP requests, in accordance with the parameters outlined by the Zoho CRM Application Programming Interface (API). The validate function is used to validate and format user data, specific to the requirements and parameters outlined by the Zoho CRM API. The lookup function is used to lookup or search and is performed to determine if there are records in the Zoho CRM that match users in the application database 126. If a match is found, the update function is performed to update a user's record in the Zoho CRM with the new data from application database 126. If no match is found, the create function is performed to create a new lead record in the Zoho CRM using data from application database 126.

In the illustrated embodiment, the building design loads database 130 holds or stores building design load values for corresponding geographical locations within a region. In the illustrated embodiment, the building design loads database 130 holds building design load value records for one or more or all counties within the United States that can be sorted by a zip code, a residential or business address, a specific pairing of latitude decimal degrees and longitude decimal degrees in a Cartesian coordinate grid or by Global Positioning Satellite (GPS) coordinates. In other embodiments, the building design loads database 130 holds building design load value records for countries other than the United States that can be sorted by a residential or business address, a specific pairing of latitude decimal degrees and longitude decimal degrees in a Cartesian coordinate grid or by GPS coordinates.

In the illustrated embodiment, the building design loads database 130 holds building design load values for corresponding geographical locations that include wind load values or limits, snow load values or limits, and seismic load values or limits. In other embodiments, the building design loads database 130 can hold building design load values for corresponding geographical locations that include tornado, hurricane and rain design load values or limits. The building design load values stored by building design loads database 130 are used to determine a cost or price of a building or prefabricated metal building by enabling an accurate estimation of materials for building dimension options and/or building accessory options for the building or structure that are sufficient to meet the design load values. In the illustrated embodiment, building design loads database 130 is hosted on a Google cloud platform and may be accessed via Google Sheets API protocols. In other embodiments, building design loads database 130 can be hosted using other suitable platforms or protocols.

In the illustrated embodiment, UX service 132 is a service that defines a list of rules that, only when met, will return instructions to front end application 122 via back end application 124 for displaying or hiding specific items or elements on GUI 106 of user device 102. When back end application 124 sends design load values for a geographical location (e.g., a wind speed value, a snow load value, and/or a seismic value) to UX service 132, UX service 132 returns instructions to back end application 124 that indicate which alert message options, building accessory options and building dimension options stored in application database 126 to render or include in a building design option menu rendered on the GUI 106 displayed on the user device 102 (see also, FIGS. 7-10).

In the illustrated embodiment, cost service 134 is a service that uses data from the user via user device 102 and from subsequent services that include, but are not limited to, the applications and services illustrated at 120-130 and 134-146. Cost service 134 generates a price for building materials that is based on a cost to manufacture the materials for a metal building. These steel materials can include, as an example, items such as doors, I-beams, bar joists, purlins, rib panels, metal panels, sidewalls and endwalls. The cost to manufacture the materials for the metal building that is determined by cost service 134 can also be based on a current market price for steel. Steel is a worldwide commodity and the price of steel can change daily. Cost service 134 can itemize costs by each available building accessory option and building dimension option presented to the user via GUI 106 on user device 102 by the front end application 122. Cost service 134 can also itemize the price of the building materials for selected building dimensions and/or the selected building accessories that have been selected by the user via GUI 106 on user device 102 and can present the itemized price list for the building materials to the user via GUI 106 on user device 102 via the front end application 122.

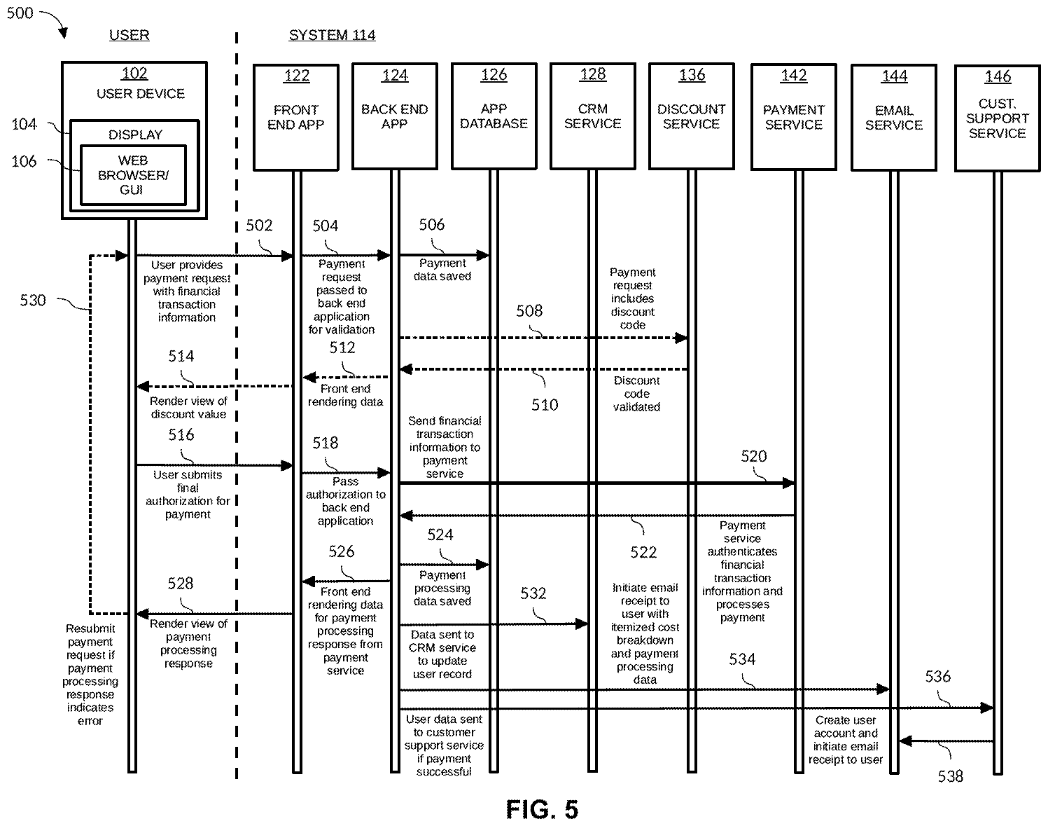

In the illustrated embodiment, discount service 136 is a service that enables the definition of discount codes during a purchase and checkout process by a user (see also, FIG. 5). Discount service 136 provides a finite and granular control of one or more itemized costs as calculated or determined by cost service 134.

In the illustrated embodiment, freight service 138 is a service that stores a list of factories that supply building materials. In one embodiment, the factories that supply the building materials are steel fabrication factories and the building materials are for a prefabricated metal building. Freight service 138 sends a request to a mapping service 140 to determine the smallest factory driving distance between a user or customer's geographical location and one or more factories and computes a freight cost based on a cost per unit distance (e.g., mileage) factory fee and the smallest factory travel distance. In one embodiment, freight service 138 sends a GET request (an HTTP method requesting information) to mapping service 140 and the response data from mapping service 140 is used to determine the smallest factory driving distance between the user's geographical location and the factory that is closest to the user. In the illustrated embodiment, mapping service 140 uses a Google Maps Application Programming Interface (API). The Google Maps API is used by mapping service 140 to communicate with Google Maps, which is a web mapping service developed by Google. In other embodiments, other suitable web mapping services may be used.

In the illustrated embodiment, payment service 142 is a service that processes payments for users or customers. Payment service 142 may also extend lines of credit and facilitate both mobile and web payments. Payment service 142 can utilize payment services such as Braintree or PayPal. For example, Braintree provides users or customers with a merchant account and a payment gateway. This allows the customer to pay securely, either by deposit or payment of the full cost or price, by credit card, PayPal, or PayPal credit (financed). Payment service 142 also provides responses (e.g., payment success, failure or error) to back end application 124. For payment authentication, a service such as OAuth may be used.

In the illustrated embodiment, email service 144 is a service that is used to email notifications and receipts to user device 102. Emails sent by email service 144 are stored in application database 126 by email service 144.

In the illustrated embodiment, customer support service 146 is a service that is used to provide support to users or customers. Customer support service 146 is a web application that is built on an open-source JavaScript framework called Vue.js. Content from customer support service 146 may be fed via API requests to and from the CRM service 128.

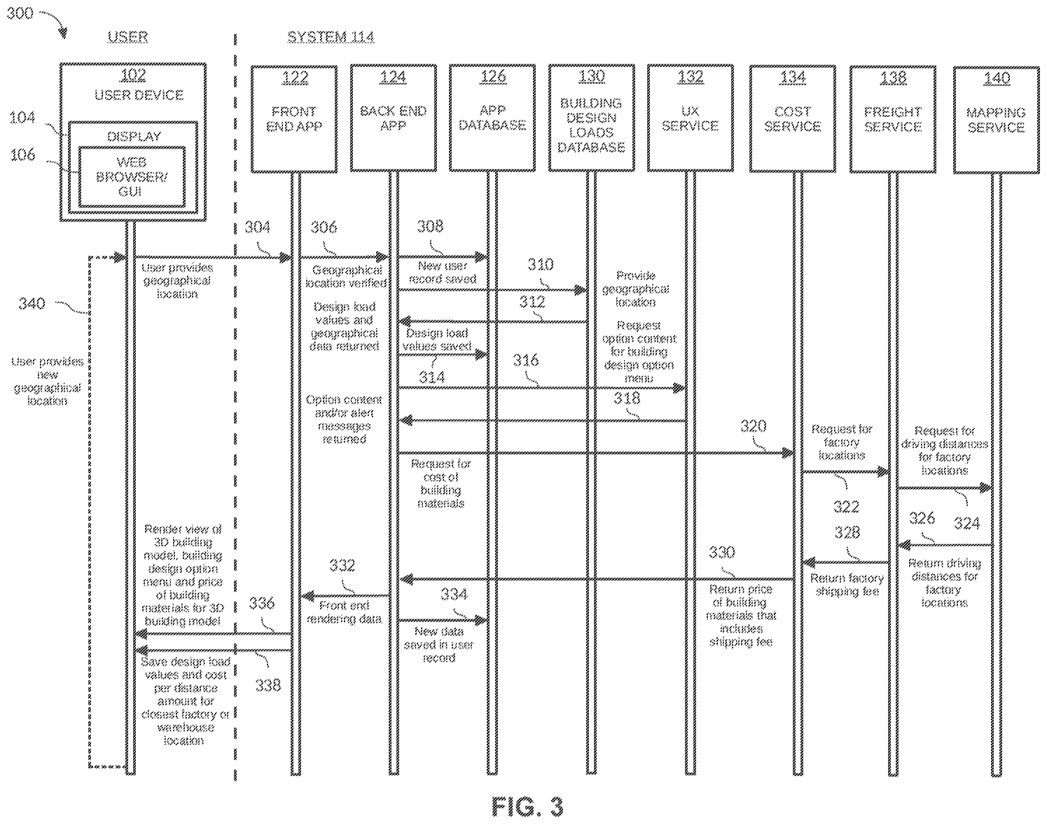

FIG. 2 illustrates a diagram at 200 of an alternative embodiment of an environment for a building design and purchase system. The building design and purchase system 200 illustrated in FIG. 2 includes the same functions and services illustrated in FIG. 1. These functions and services include, but are not limited to, application service 120 which includes front end application 122 and back end application 124, application database 126, Customer Resource Management (CRM) service 128, building design loads database 130, Universal Interface (UX) service 132, cost service 134, discount service 136, freight service 138, mapping service 140, payment service 142, email service 144 and customer support service 146. System 114 is a cloud-based system and includes front end application 122 and back end application 124. System 114 can access application database 126 via network 112 and can access services 128-146 via network 112. User device 102 interacts with system 114 via front end application 122 as illustrated in FIGS. 3-5. User device 102 can access front end application 114 via network 112. In other embodiments, any suitable organization or arrangement of application service 120, application database 126 and services 128-146 can be used.

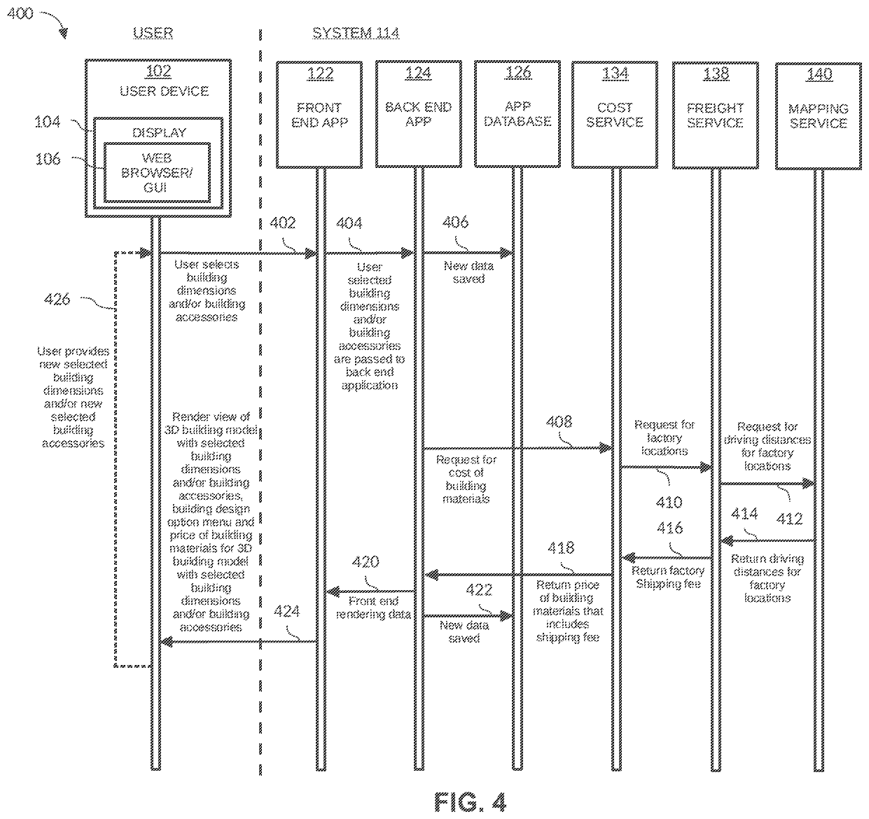

FIGS. 3-5 illustrate processes and methods at 300, 400 and 500 of the operation of the building design and purchase system 100 illustrated in FIG. 1. The processes and methods illustrated in FIGS. 3-5 include a vertical dash line that separates a user (e.g., user device 102) from a system (e.g., system 114). In the illustrated embodiments, FIG. 3 describes an embodiment of a user's initial interaction with building design and purchase system 100, FIG. 4 describes an embodiment of a user selecting building dimensions and/or building accessories and FIG. 5 describes an embodiment of a user purchasing the building or the building materials.

FIG. 3 illustrates a process diagram at 300 of an embodiment of rendering a view of a 3D building model, generating and rendering a price for building materials for the 3D building model and rendering a building design option menu on a GUI 106 displayed on a user device 102 for a geographical location entered by a user. In the embodiment illustrated in FIG. 3, the process or sequence of interactions performed by system 114 at 306 through 338 occur or execute automatically without user input or input from user device 102.

In the illustrated embodiment, a user identifies or enters a geographical location into the GUI 106 displayed on user device 102. Front end application 122 renders content on GUI 106 that allows the user to enter or identify the geographical location into GUI 106 and submit the geographical location to front end application 122. The geographical location can include, but is not limited to, a zip code, a residential or business address, a specific pairing of latitude decimal degrees and longitude decimal degrees in a Cartesian coordinate grid or Global Positioning Satellite (GPS) coordinates. In one embodiment, the geographical location is a zip code. In other embodiments, the user may also provide an email address along with the geographical location. At 306, the geographical location is sent to back end application 124 for verification. If the geographical location is invalid, content is returned to front end application 122, and front end application 122 provides content to GUI 106 that is rendered as an error message on GUI 106. In one embodiment, the geographical location may be a zip code that does not match any known zip codes in the United States, and the error message rendered on GUI includes a request that the user identify or enter a new geographical location or zip code at 304.

At 308, back end application 124 saves a new user record in application database 126. In one embodiment, back end application 124 creates a unique Uniform Resource Locator (URL) link that is associated with the user and saves the URL link along with the geographical location in application database 126. The URL link allows the user to revisit their session with system 114. In the illustrated embodiment, back end application 124 may save other information identified or entered by the user into GUI 106 such as an email address.

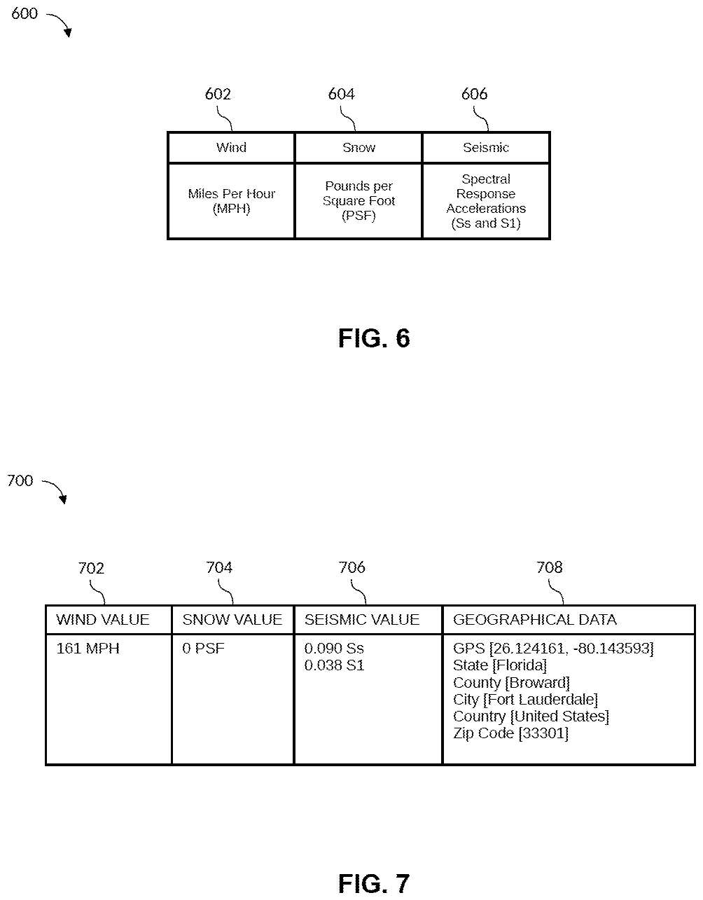

At 310, back end application 124 requests design load values for the geographical location from building design loads database 130 in response to receiving the geographical location via user identification or entry into GUI 106 displayed on user device 102. In one embodiment, backend application 124 performs an API GET request to building design loads database 130. At 310, back end application 124 may provide the geographical information as a zip code to the building design loads database 130, which returns at 312, the design load values and geographical data associated with the zip code (see also, FIG. 7). The design load values are discussed in further detail with respect to FIGS. 6-8 and include a wind speed value, a snow load value, and/or a seismic value. In other embodiments, the design load values can include other suitable values or types of values. In the illustrated embodiment, the design load values and geographical data are returned at 312 to back end application 124. In one embodiment, the geographical data includes the county seat and state associated with the zip code provided by the user. In one embodiment, the geographical data includes one or more of a zip code, a city, a county, a state, a country, a specific pairing of latitude decimal degrees and longitude decimal degrees in a Cartesian coordinate grid or GPS coordinates (see also, FIG. 7). In the illustrated embodiment, the design load values and the geographical data are saved at 314 to the user's record in application database 126 (see also, FIG. 7).

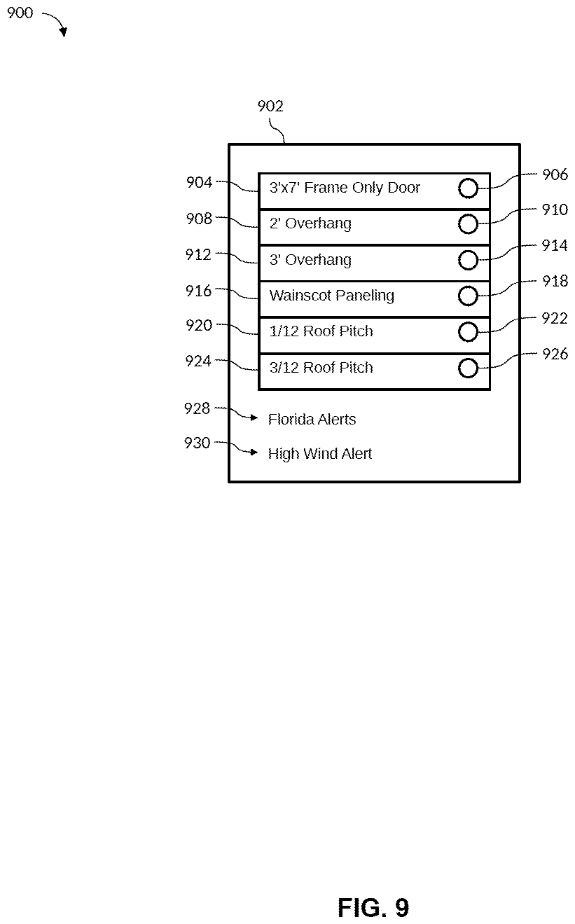

At 316, back end application 124 requests option content from Universal Interface (UX) service 132 to include in the building design option menu to be rendered on the GUI 106 displayed on the user device 102 (see also, FIGS. 9-14). The building design option menu includes information fields for each one of one or more building dimension options for a Three-Dimensional (3D) building model and for each one of one or more building accessory options for the 3D building model. At 318, the option content including the one or more building dimension options and/or the one or more building accessory options that meet or exceed the design load values are returned from UX service 132 to back end application 124. In addition, alert messages may be returned to back end application 124 (see also, FIGS. 7-9). For example, if one or more of the design load values (e.g., snow, wind, or seismic values) in the request at 316 falls within certain limits, as defined by UX service 132, one or more alert messages are returned at 318 to back end application 124 (see also, FIGS. 7-10).

At 320, back end application 124 sends a request for a cost of building materials for the 3D building model to cost service 134. With the first rendering of the building design option menu, the cost of building materials is for a preselected 3D building model. The preselected 3D building model may include, for example, preselected building dimensions such as a width, length, height and a roof pitch (see also, FIG. 11). In the illustrated embodiment, cost service 134 generates or calculates the cost for building materials that is based on a cost to manufacture the materials for a metal building such as a prefabricated metal building. The steel materials used for the metal building can include, but are not limited to, items such as doors, I-beams, bar joists, purlins, rib panels, metal panels, sidewalls and endwalls. The cost to manufacture the materials for the metal building that is determined by cost service 134 can also be based on a current market price for steel. Steel is a worldwide commodity, and the price of steel can change daily which can affect the overall price of the metal building. Cost service 134 includes or has access to a database that stores the current price of steel and/or the current price of the building dimension options and the building accessory options. In other embodiments, cost service 134 can generate the cost for building materials for other types of buildings.

At 322, cost service 134 sends a request to freight service 138 for a location of one or more factories that supply the building materials for the preselected 3D building model. In the illustrated embodiment, the factory locations are stored locally in freight service 138. In other embodiments, the factory locations may be stored in any suitable location such as a cloud-based location.

At 324, freight service 138 sends a request to mapping service 140 to determine a factory travel distance between each one of the one or more factories that supply the building materials and the geographical location provided by the user at 304 and 306. In the illustrated embodiment, mapping service 140 is a web-based mapping service.

At 326, mapping service 140 returns to freight service 138 a factory travel distance between each one of the one or more factories that supply the building materials and the geographical location provided by the user. Based on the factory travel distance between each one of the one or more factories that supply the building materials and the geographical location, freight service 138 identifies the one of the one or more factories that is closest to the geographical location provided by the user and therefore has the smallest factory travel distance. Freight service 138 calculates a factory shipping fee for the building materials that is determined from a cost per unit distance factory fee and the smallest factory travel distance. In one embodiment, the factory shipping fee is calculated by multiplying the cost per unit distance factory fee by the smallest factory travel distance. For example, with units of distance in miles, the factory shipping fee is equal to a cost/mile fee multiplied by the smallest factory travel distance in miles.

At 328, freight service 138 returns the factory shipping fee to cost service 134. Cost service 134 calculates the price of the building materials by adding the cost of the building materials to the factory shipping fee. At 330, cost service 134 returns the price of the building materials that includes the factory shipping fee to back end application 124. In the illustrated embodiment, cost service 134 itemizes the price of the building materials and returns, at 330, the itemized price list of the building materials to back end application 124. In other embodiments, cost service 134 provides the price of the building materials and does not provide the itemized price list of the building materials to back end application 124.

At 332, front end rendering data is sent from back end application 124 to front end application 122. At 334, back end application 124 saves the price of the building materials including the itemized price list that includes the factory shipping fee to the user's record in application database 126. Back end application 124 also saves the option content to include in the building design option menu and any alert messages to the user's record in application database 126. Back end application 124 may also save the factory shipping fee, the cost per unit distance factory fee and/or the smallest factory travel distance to the user's record in application database 126.

At 336, front end application 122 renders a view of the 3D building model, the price for building materials for the 3D building model and a building design option menu on the GUI 106 displayed on a user device 102. In the illustrated embodiment, the view of the 3D building model and the price of the building materials for the 3D building model is for a preselected 3D building model that includes selected building dimensions and/or selected building accessories that have been predetermined. The rendering of the preselected 3D building model may provide a user with an initial 3D building model view from which to select building dimensions and/or select building accessories to finalize the 3D building model in accordance with the user's preferences.

At 338, front end application 122 saves data in the local memory in the web browser/GUI 106 in order to make the building design and purchase system 100 more performant. In one embodiment, the data is saved in the one or more memories 110 illustrated in FIG. 1. Saving the data allows the user to interact with system 114 without having to rerun or access services such as the building design loads database 130, UX service 132, freight service 138 and mapping service 140. In one embodiment, this allows the user to interact with system 114 without having to rerun or access services such as the building design loads database 130, UX service 132, freight service 138 and mapping service 140 as long as the geographical location provided by the user at 304 and 306 remains the same. The data saved at 338 by front end application 122 includes the design load values, the geographical data, and one or more of the factory shipping fee, the cost per unit distance factory fee and the smallest factory travel distance. In the illustrated embodiment, if the user provides a new geographical location at 340 and 304 that is different than the previous geographical location received from the user device 102, system 114 automatically determines the option content to include in the building design option menu and the price of the building materials by performing the process or sequence of interactions illustrated at 306 through 338.

FIG. 4 illustrates a diagram at 400 of an embodiment of rendering a view of a 3D building model, generating and rendering a price for building materials for the 3D building model and rendering a building design option menu on a GUI 106 displayed on a user device 102 for building dimensions and/or building accessories selected by a user. Referring to FIG. 3, at 336, front end application 122 renders the building design option menu that includes the one or more building dimension options and/or the one or more building accessory options that meet or exceed the design load values on the GUI 106 displayed on the user device 102. The building design option menu includes information fields for each one of one or more building dimension options for the 3D building model and for each one of one or more building accessory options for the 3D building model (see also, FIGS. 8-14).

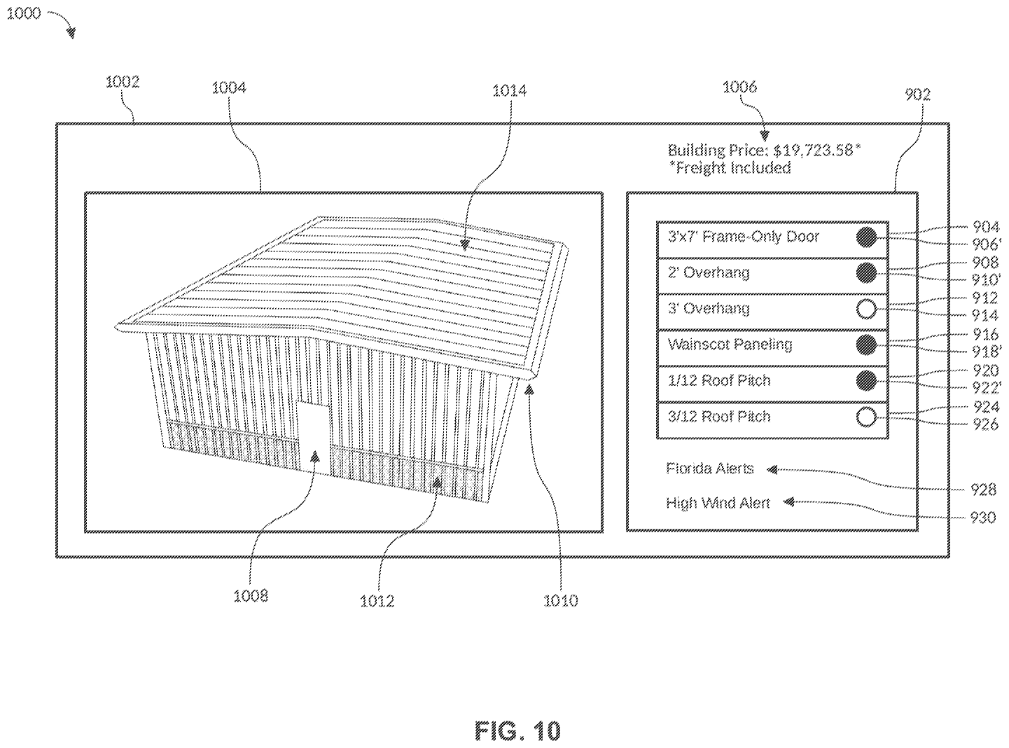

Referring to FIG. 4, at 402, the user selects building dimensions by identification or entry into information fields for at least one of the one or more building dimension options via the GUI 106 displayed on the user device 102 and/or selects building accessories by identification or entry into information fields for at least one of the one or more building accessory options via the GUI 106 displayed on the user device 102 (see also, FIG. 10). In various embodiments, the identification, entry or selection of the building dimensions and/or the building accessories can be completed, for example, by using a keyboard, computer mouse or touchscreen for a computer, laptop, tablet, phone or other suitable device.

At 404, the selected building dimensions and/or building accessories are sent to back end application 124. At 406, back end application 124 saves the selected building dimensions and/or building accessories in the user's record on application database 126. At 408, back end application 124 sends a request for a cost of building materials for the 3D building model to cost service 134. The cost of building materials includes the selected building dimensions and/or the selected building accessories. In the illustrated embodiment, cost service 134 generates or calculates the cost for building materials that is based on the cost to manufacture the materials for a metal building such as a prefabricated metal building. The cost to manufacture the materials for the metal building that is determined by cost service 134 can also be based on the current market price for steel. In other embodiments, cost service 134 can generate the cost for building materials for other types of buildings.

At 410, cost service 134 sends a request to freight service 138 for a location of one or more factories that supply the building materials that include the selected building dimensions and/or the selected building accessories. In the illustrated embodiment, the factory locations are stored locally in freight service 138. In other embodiments, the factory locations may be stored in any suitable location such as a cloud-based location.

At 412, freight service 138 sends a request to mapping service 140 to determine a factory travel distance between each one of the one or more factories that supply the building materials and the geographical location provided by the user at 304 and 306 (see also, FIG. 3). In the illustrated embodiment, mapping service 140 is a web-based mapping service.

At 414, mapping service 140 returns to freight service 138 a factory travel distance between each one of the one or more factories that supply the building materials and the geographical location provided by the user at 304 and 306 (see also, FIG. 3). Based on the factory travel distance between each one of the one or more factories that supply the building materials and the geographical location, freight service 138 identifies the one of the one or more factories that is closest to the geographical location provided by the user and therefore has the smallest factory travel distance. Freight service 138 calculates a factory shipping fee for the building materials that is determined from a cost per unit distance factory fee and the smallest factory travel distance. In one embodiment, the factory shipping fee is calculated by multiplying the cost per unit distance factory fee by the smallest factory travel distance. For example, with units of distance in miles, the factory shipping fee is equal to a cost/mile fee multiplied by the smallest factory travel distance in miles.

At 416, freight service 138 returns the factory shipping fee amount to cost service 134. Cost service 134 calculates the price of the building materials by adding the cost of the building materials to the factory shipping fee. At 418, cost service 134 returns the price of the building materials that includes the factory shipping fee to back end application 124. In the illustrated embodiment, cost service 134 itemizes the price of the building materials by the selected building dimensions and/or the selected building accessories and returns, at 418, the itemized price list of the building materials to back end application 124. In other embodiments, cost service 134 provides the price of the building materials and does not provide the itemized price list of the building materials to back end application 124.

At 420, front end rendering data is sent from back end application 124 to front end application 122. At 422, back end application 124 saves the price of the building materials including the itemized price list that includes the factory shipping fee to the user's record in application database 126.

At 424, front end application 122 renders on the GUI 106 displayed on the user device 102 a view of the 3D building model that has been modified to include the selected building dimensions and/or the selected building accessories and a price of building materials for the 3D building model that has been modified to include the selected building dimensions and/or the selected building accessories (see also, FIG. 10). In the illustrated embodiment, the price of building materials is an itemized price list of the building materials that is itemized by the selected building dimensions and/or the selected building accessories. In one embodiment, front end application 122 also renders the building design option menu that includes the option content on the GUI 106 displayed on the user device 102 (see also, FIG. 3). In the illustrated embodiment, if the user provides new selected building dimensions and/or new selected building accessories at 426 and 402, system 114 renders on the GUI 106 displayed on the user device 102 a view of the 3D building model that has been modified to include the new selected building dimensions and/or the new selected building accessories and a new price of building materials for the 3D building model has been modified to include the new selected building dimensions and/or the new selected building accessories by performing the process or sequence of interactions illustrated at 404 through 424 (see also, FIG. 10).

In one embodiment, front end application 122 saves data in the local memory in the web browser/GUI 106 in order to make the building design and purchase system 100 more performant as illustrated in FIG. 3. The data is saved in the local memory prior to the user selecting building dimensions and/or building accessories at 402 and 404 and includes the design load values, the geographical data, and one or more of the factory shipping fee, the cost per unit distance factory fee and the smallest factory travel distance. In this embodiment, cost service 134 does not access freight service 138 and mapping service 140 as illustrated at 410, 412, 414 and 416. Rather, cost service 134 utilizes the factory shipping fee stored in the local memory of web browser/GUI 106 or the one or more memories 110 on user device 102 to calculate the price of the building materials by adding the cost of the building materials to the factory shipping fee. In this embodiment, once the user has selected building dimensions and/or building accessories at 402 and 404 and the request at 408 for the cost of building materials for the 3D building model is sent to cost service 134, cost service 134 obtains the factory shipping fee via back end application 124 and front end application 122 from user device 102. Obtaining the factory shipping fee from user device 102 means freight service 138 and mapping service 140 as illustrated at 410, 412, 414 and 416 are not used. Cost service 134 then calculates the price of the building materials by adding the cost of the building materials to the factory shipping fee. At 418, cost service 134 returns the price of the building materials that includes the factory shipping fee to back end application 124. The process or sequence of interactions performed by system 114 at 420 through 424 remain the same.

In the illustrated embodiment, back end application 124 sends a request to email service 144 to send an email to the user with a unique Uniform Resource Locator (URL) link that is associated with the user and saves the URL link in application database 126 (see also, FIG. 5). The email is sent after the user logs out or disengages with front end application 122 and system 114. The URL link, when accessed, allows the user to revisit their session with system 114 by requesting front end application 122 to render on the GUI 106 displayed on the user device 102 the view of the 3D building model that has been modified to include the selected building dimensions and/or the selected building accessories and the price of building materials for the 3D building model has been modified to include the selected building dimensions and/or the selected building accessories. Another email may be sent to a business that is using system 114 to inform the business of user activity or new user activity with regards to system 114. The email sent to the business may also include user data stored in the user's record in application database 126. The success or failure of email service 144 may also be stored in the user's record in application database 126. A failure of email service 144 would occur for example, if the email used by email service 144 to contact the user was not valid.

FIG. 5 illustrates a diagram of an embodiment at 500 of processing a payment request for payment of the price of building materials for a 3D building model that includes building dimensions and/or building accessories selected by a user. In the illustrated embodiment, the user provides a payment request at 502 to front end application 122 via user identification or entry into the GUI 106 displayed on the user device 102. The payment request is a checkout request and includes the user identifying or entering into the GUI 106 displayed on user device 102 any financial transaction information needed for system 114 to process the payment. The payment request at 502 may also include an optional discount code. One example of a discount code is the “Florida Alerts” at 928 illustrated in FIGS. 9-10 that represents text of a message that reads “Florida residents get an extra 10% off all wind-rated walk doors. Enter promo code HOLDTIGHT2021”. The discount code is the “HOLDTIGHT2021” and would be entered into the GUI 106 displayed on the user device 102 along with the financial transaction information.

In the illustrated embodiment, at 504, the payment request is passed to back end application 124 for validation. Validation of the payment request includes, but is not limited to, confirmation that the financial transaction information provided by the user is valid. At 506, the payment data is saved. This includes the financial transaction information and the discount code, if any. At 508, if the user has entered a discount code into the GUI 106 displayed on the user device 102, discount service 136 validates the discount code against a database of available discount codes. The database of available discount codes may be stored locally with discount service 136, or may be stored at another suitable location such as within application database 126. If discount service 136 has validated the discount code by finding a match in the database of available discount codes, the discount code validation is returned at 510 to backend application 124. If discount service 136 did not find a match in the database of available discount codes, an error message is returned at 510 to back end application 124. At 512, backend application 124 provides front end rendering data to front end application 122. At 514, front end application 122 renders a view of the price of the building materials on the GUI 106 displayed on the user device 102 with the discount applied and supporting text if discount service 136 has validated the discount code. If discount service 136 has not validated the discount code, at 514, an error message will be rendered on the GUI 106 displayed on the user device 102. At 516, the user approves/submits a final authorization for payment by identification or entry into the GUI 106 displayed on the user device 102. At 518, front end application 122 passes the final authorization to back end application 124. At 520, back end application 124 sends the financial transaction information to payment service 142 for authentication in response to receiving the final authorization for payment at 516 and 518.

In the illustrated embodiment, payment service 142 is a service that processes payments for users. In various embodiments, payment service 142 utilizes payment services such as Braintree or PayPal. Braintree can provide a user with a merchant account and a payment gateway which allows the ability to pay securely, either by deposit or payment of the full cost or price, by credit card, PayPal, or by PayPal credit (financed). Payment service 142 authenticates the financial transaction information and processes the payment. For payment authentication, a service such as OAuth may be used. At 522, payment service 142 provides a response to back end application 142 that indicates either success or failure of the processing of the payment. At 524, back end application saves the response from payment service 142 to the user's record in application database 126. At 526, back end application 124 provides front end rendering data for the payment processing response from payment service 142. At 528, front end application 122 renders a view of the payment processing response from payment service 142 on GUI 106 displayed on user device 102. If payment service 142 provides a response to back end application 124 that indicates success of the processing of the payment in response to payment service 142 authenticating the financial transaction information and processing the payment for the price of the building materials, front end application 122 will render a view of the payment processing response that indicates the payment request was successful. If payment service 142 provides a response to back end application 124 that indicates failure of the processing of the payment, front end application 122 will render a view of the payment processing response that indicates an error and that the payment request was not successful. At 530, the user will have the ability to resubmit the payment request with new financial transaction information or resubmit the same financial transaction information for reauthorization by payment service 142 if the payment processing response at 528 indicated an error.

In the illustrated embodiment, at 532, back end application 124 sends data stored in the user's record in application database 126 to the Customer Relationship Management (CRM) service 128. CRM service 128 performs database functions with regards to the data stored in the user's record as described with respect to FIG. 1. At 534, back end application 124 sends a request to email service 144 to send an email receipt to the user that includes an itemized cost breakdown and payment processing data. At 536, data stored in the user's record in application database 126 is sent to customer support service 146 if the payment request was successful. At 538, customer support service 146 creates a new user account and sends a request to email service 144 to send a welcome email with login credentials to the user.

FIG. 6 illustrates an embodiment at 600 of types of building design loads. Building codes and building design load requirements are usually enforced by a city or town building department and can vary between different geographical locations. The building design loads include a wind rating at 602, which is specified in Miles Per Hour (MPH), a snow rating at 604, which is specified in Pounds per Square Foot (PSF) and a seismic rating at 606 which is specified in spectral response accelerations where Ss is for short periods (0.2 sec.) and 51 is for long periods (1.0 sec.). In other embodiments, the types of building design loads can include, but are not limited to, tornado, hurricane and rain design loads.

FIG. 7 illustrates an embodiment at 700 of a record of building design load values and geographical data generated in response to receiving a geographical location from a user device 102. Referring also to FIG. 3, at 310, back end application 124 requests design load values for the geographical location from building design loads database 130 in response to receiving the geographical location via user identification or entry into GUI 106 on user device 102. At 310, back end application 124 may provide the geographical location as a zip code or postal code to the building design loads database 130. Building design loads database 130 returns at 312, the design load values associated with the geographical region that the zip code specifies. In other embodiments, generating the design load values for the geographical location further includes generating geographical data in response to receiving the geographical location. The geographical data includes one or more of a zip code, a city, a county, a state, a country, a specific pairing of latitude decimal degrees and longitude decimal degrees in a Cartesian coordinate grid or Global Positioning Satellite (GPS) coordinates.

Referring to FIGS. 3 and 7, an exemplary zip code (e.g., 33301) is provided at 310. The building design loads database 130 returns at 312 the record illustrated at 700 that includes the building design load values illustrated at 702, 704 and 706 and the geographical data illustrated at 708. The building design load values include a wind value 702 of 161 MPH, a snow value 704 of 0 PSF and a seismic value 706 of 0.090 Ss and 0.038 Sl. The geographical data illustrated at 708 includes the zip code [33301] and GPS coordinates [26.124161, −80.143593], which specify a smaller geographical region. Additional geographical data 708 includes relatively larger geographical region data relative to the zip code [33301] and GPS coordinates [26.124161, −80.143593] and includes a City [Fort Lauderdale], a County [Broward], a State [Florida] and a Country [United States]. In various embodiments, the building design loads database 130 holds building design load value records for one or more or all counties within the United States that can be sorted by a zip code, a residential or business address, a specific pairing of latitude decimal degrees and longitude decimal degrees in a Cartesian coordinate grid or GPS coordinates.

FIG. 8 illustrates an embodiment at 800 of alert message options, building accessory options and building dimension options. The embodiment illustrated in FIG. 8 is in a table format and includes option types 802 that include alert message options 818, building accessory options 828 and building dimension items 842. In various embodiments, table 800 can include any suitable number of alert message options 818, building accessory options 828 and/or building dimension options 842. For example, table 800 can include corresponding entries with design load limits, if any, for any suitable building design option menu elements. The building design option menu elements illustrated in FIGS. 11-14 are additional examples of building design option menu elements.

In the illustrated embodiment, table 800 is stored in application database 126. Table 800 contains a list of alert message options 818, building accessory options 828 and building dimension options 842 at 804 that are searchable via location information 806 (e.g., for alert message options 818) and via design load limits that include wind load limits 808, snow load limits 810 and seismic load limits 812, for inclusion in a building design option menu rendered on a GUI 106 displayed on a user device 102 (see also, FIGS. 9-14). The wind load limits 808 are specified in Miles Per Hour (MPH), the snow load limits 810 are specified in Pounds per Square Foot (PSF), and the seismic load limits 812 are specified using the spectral response accelerations of Ss and Sl. The building accessory options 828 and building dimension options 842 illustrated for elements 804 are specified in terms of feet. In other embodiments, any suitable units of measurement for the wind load limits 808, the snow load limits 810, the seismic load limits 812, the building accessory options 828 and the building dimension options 842 may be used.

In the illustrated embodiment, for alert message options 818, table 800 includes “Florida Alerts” at 820 with a location of “Florida”, an “Extreme Wind Alert” at 822 with a wind load limit 808 that is greater than 190 MPH (e.g., “>190 MPH”), a “High Wind Alert” at 824 with a wind load limit 808 that is greater than 150 MPH (e.g., “>150 MPH”) and an “Earthquake Alert” at 826 with a seismic load limit 812 that is greater than 1.3 Ss and 0.6 Sl (e.g., “>1.3 Ss, >0.6 Sl”). For building accessory options 828, table 800 includes a “3′×7′ Frame Only Door” at 830 with no building design load limits and a price 816 of $125, a “3′×7′ Wind Rated Door” at 832 with a wind load limit 808 that is equal to or less than 160 MPH (e.g., “<160 MPH”) and a price 816 of $895, a “3′×3′ Wind Rated Window” at 834 with a wind load limit 808 that is equal to or less than 160 MPH (e.g., “<160 MPH”) and a price 816 of $297, a “2′ Overhang” at 836 with no building design load limits and a price 816 of $25, a “3′ Overhang” at 838 with a snow load limit 810 that is equal to or less than 36 PSF (e.g., “<36 PSF”) and a price 816 of $30, and “Wainscot Paneling” at 840 with no building design load limits and a price 816 of $20. For building dimension options 842, table 800 includes a “ 1/12 Roof Pitch” at 844 with no building design load limits and a price 816 of $25 and a “ 3/12 Roof Pitch” at 846 with a snow load limit 810 that is equal to or less than 20 PSF (e.g., “<20 PSF”) and a price 816 of $30.

In the illustrated embodiment, each one of the alert message options 818, the building accessory options 828 and the building dimension options 842 includes content 814 illustrated as HTML, or both HTML, and JavaScript. For each of the alert message options 818, the building accessory options 828 and the building dimension options 842 that are included in the building design option menu rendered on the GUI 106 displayed on the user device 102, the HTML content generates text or building design option menu content that is rendered on GUI 106 while the JavaScript content performs a change or action (see also, FIGS. 9-14). One example of the change or action performed by the JavaScript content is to hide or not display a price of building materials for the 3D building model if the “Extreme Wind Alert” at 822, the “High Wind Alert” at 824 or the “Earthquake Alert” at 826 is rendered on GUI 106.

FIG. 9 illustrates an embodiment at 900 of a building design option menu 902 rendered on a GUI 106 displayed on a user device 102 that includes the alert message options 818, the building accessory options 828 and the building dimension options 842 illustrated in FIG. 8 that meet the building design load values 702, 704 and 706 and the geographical data 708 illustrated in FIG. 7. Referring FIG. 1 and FIG. 9, UX service 132 will return instructions to front end application 122 via back end application 124 for displaying or hiding specific items or elements of the building design option menu 902 on GUI 106 of user device 102. When back end application 124 sends design load values for a geographical location (a wind speed value 702, a snow load value 704, and a seismic value 706) to UX service 132, UX service 132 returns instructions to back end application 124 that indicate which alert message options 818, building accessory options 828 and building dimension options 842 stored in application database 126 to render or include in the building design option menu 902.

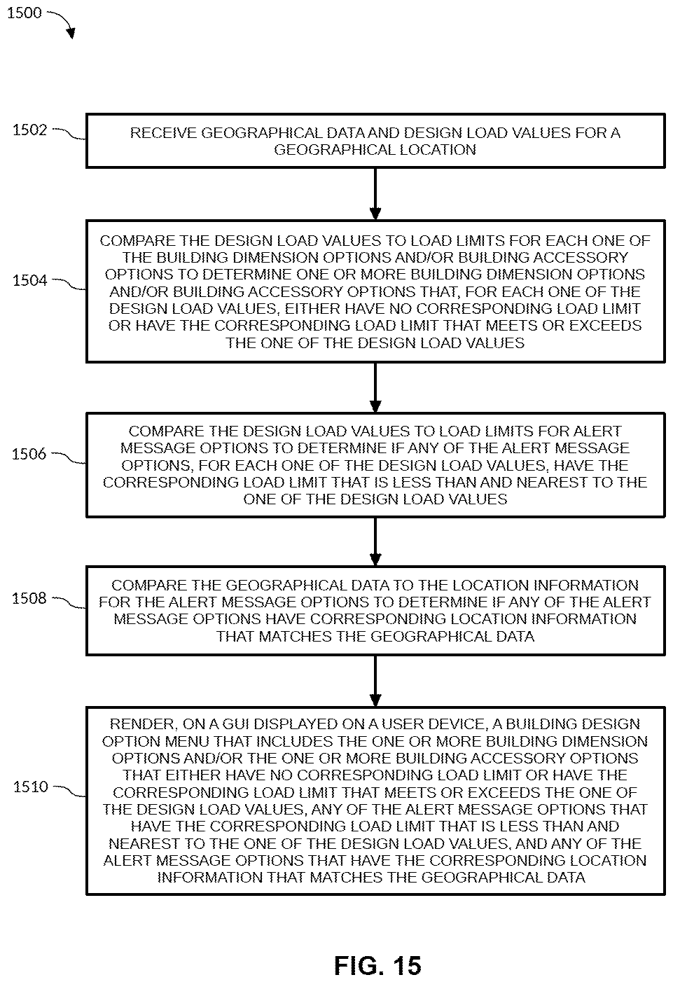

FIG. 15 illustrates a flowchart at 1500 of an embodiment of a method of generating a building design option menu to be rendered on the GUI 106 displayed on user device 102 by determining option content for the building design option menu that includes the building dimension options and/or building accessory options and alert messages that meet or exceed the design load values for a geographical location provided by a user. In the illustrated embodiment, a building design option menu is generated for a Three-Dimensional (3D) building model. Although the embodiment described in FIG. 15 is illustrated with respect to FIGS. 7-10, in other embodiments, the method described in FIG. 15 can be used to generate any suitable building design option menu with building dimension options and/or building accessory options and alert messages that are rendered on a GUI 106 of a user device 102 for a geographical location provided by a user.

At 1502, geographical data 708 and design load values 702, 704 and 706 are received for a geographical location (e.g., 304 in FIG. 3) provided by a user. At 1504, UX service 132 compares the design load values 702, 704 and 706 to load limits 808, 810 and 812 for each one of the building dimension options 842 and/or building accessory options 828 to determine the one or more building dimension options 842 and/or building accessory options 828 that, for each one of the design load values 702, 704 and 706, either have no corresponding load limit 808, 810 and 812, or have the corresponding load limit 808, 810 and 812 that meets or exceeds the one of the design load values 702, 704 and 706. The elements 804 in table 800 that would be identified by UX service 132 for inclusion in the building design option menu would include the “3′×7′ Frame Only Door” at 830, the “2′ Overhang” at 836, the “Wainscot Paneling” at 840 and the “ 1/12 Roof Pitch” at 844 as they have no load limit requirements for 808, 810 and 812. The elements 804 in table 800 that would be identified by UX service 132 for inclusion in the building design option menu would also include the “3′ Overhang” at 838 because the design load snow value 704 of 0 PSF is equal to or less than the snow load limit 810 of 36 PSF, and would include the “ 3/12 Roof Pitch” at 846 because the design load snow value 704 of 0 PSF is equal to or less than the snow load limit 810 of 20 PSF. The “3′×7′ Wind Rated Door” at 832 with a wind load limit 808 that is equal to or less than 160 MPH and the “3′×3′ Wind Rated Window” at 834 with a wind load limit 808 that is equal to or less than 160 MPH would not be identified by UX service 132 for inclusion in the building design option menu because the design load wind value 702 of 161 MPH is greater than the wind load limit 808 of 160 MPH for both the “3′×7′ Wind Rated Door” at 832 and the “3′×3′ Wind Rated Window” at 834.

At 1506, UX service 132 compares the design load values 702, 704 and 706 to load limits 808, 810 and 812 for each one of the alert message options 818 to determine if any of the alert message options 818, for each one of the design load values 702, 704 and 706, have the corresponding load limit 808, 810 and 812 that is less than and nearest to the one of the design load values 702, 704 and 706. The elements 804 in table 800 that would be identified by UX service 132 would include the “High Wind Alert” at 824 with a wind load limit 808 that is greater than 150 MPH but would not include the “Extreme Wind Alert” at 822 with a wind load limit 808 that is greater than 190 MPH. This is because the design load wind value 702 of 161 MPH is greater than 150 MPH for the “High Wind Alert” at 824 but is less than 190 MPH for the “Extreme Wind Alert” at 822. If more than one of the alert message options 818 is identified by UX service 132 for the same design load value (e.g., the same wind value 702, snow value 704 or seismic value 706), only one of the alert message options 818 having the corresponding load limit 808, 810 or 812 that is less than and nearest to the one of the design load values 702, 704 or 706 would be returned. For example, while a wind value 702 of 195 MPH is greater than both the wind load limit 808 of 150 MPH for the “High Wind Alert” at 824 and the wind load limit 808 of 190 MPH for the “Extreme Wind Alert” at 822, only the highest “Extreme Wind Alert” at 822 would be identified by UX service 132 for rendering on the GUI 106 of user device 102. This is because it is the one of the alert message options 818 that has the corresponding wind load limit 808 of 190 MPH that is less than and nearest to the design load wind value 702 of 195 MPH. The alert message options 818 that would not be identified by UX service 132 include the “Earthquake Alert” at 826 with the seismic load limit 812 that is greater than 1.3 Ss and 0.6 Sl. This is because the design load seismic value 706 of 0.090 Ss and 0.038 Sl are respectively less than 1.3 Ss and 0.6 Sl for the “Earthquake Alert” at 826.

At 1508, UX service 132 compares the geographical data 708 to the location information 806 for the alert message options 818 to determine if any of the alert message options 818 have corresponding location information 806 that matches the geographical data 708. The “Florida Alerts” at 820 with a location of “Florida” would be identified by UX service 132 because the location information 806 of “Florida” matches the State [Florida] included in the geographical data 708.

At 1510, a building design option menu 902 that includes the option content is rendered on the GUI 106 displayed on the user device 102. The building design option menu 902 includes the one or more building dimension options 842 and/or the one or more building accessory options 828 that have no corresponding load limit 808, 810 and 812 (e.g., the “3′×7′ Frame Only Door” at 830, the “2′ Overhang” at 836, the “Wainscot Paneling” at 840 and the “ 1/12 Roof Pitch” at 844). These are illustrated respectively at 904, 908, 916 and 920 and may be selected by the user via the respective information fields 906, 910, 918 and 922 displayed on the user device 102 (see also, FIG. 10). In the illustrated embodiment, the content 814 for 830, 836, 840 and 844 is HTML content that provides a universal interface or text which is rendered or printed on the GUI 106 of user device 102 as illustrated at 904, 908, 916 and 920 with information fields 906, 910, 918 and 922.

The building design option menu 902 includes the one or more building dimension options 842 and/or the one or more building accessory options 828 that have the corresponding load limit 808, 810 and 812 that meets or exceeds the design load values 702, 704 and 706 (e.g., the “3′ Overhang” at 838 and the “ 3/12 Roof Pitch” at 846). These are illustrated respectively at 912 and 924 and may be selected by the user via the respective information fields 914 and 926 displayed on the user device 102 (see also, FIG. 10). In the illustrated embodiment, the content 814 for 838 and 846 includes HTML and JavaScript content that provides the universal interface or text which is rendered or printed on the GUI 106 of user device 102 and which is illustrated at 912 and 924 with information fields 914 and 926.

The building design option menu 902 includes any of the alert message options 818 that have the corresponding load limit 808, 810 and 812 that are less than and nearest to the one of the design load values 702, 704 and 706 (e.g., the “High Wind Alert” at 824) which is illustrated at 930, and includes any of the alert message options 818 that have the corresponding location information 806 that matches the geographical data 708 (e.g., the “Florida Alerts” at 820) which is illustrated at 928. In the illustrated embodiment, the content 814 for 820 and 824 includes HTML and JavaScript content that provides the universal interface or text which is rendered or printed on the GUI 106 of user device 102 and which is illustrated at 928 and 930.

In one embodiment, the alert message options 818 that have the corresponding location information 806 that matches the geographical data 708 can be used to create an alert that is determined by user location. For example, the “Florida Alerts” at 928 represents a placeholder for text of a message such as “Florida residents get an extra 10% off all wind-rated walk doors. Enter promo code HOLDTIGHT2021”.

In the illustrated embodiment, the JavaScript content at 814 for the “High Wind Alert” at 824 may be utilized to enact a change or action. In one embodiment, the change or action is performed because the “High Wind Alert” at 824 has the corresponding load limit 808, 810 and 812 that meets or exceed the design load values 702, 704 and 706. In this case, the wind value 702 of 161 MPH is greater than the wind load limit 808 of 150 MPH for the “High Wind Alert” at 824, and the JavaScript content is utilized to hide the price of building materials or building price at 1006 which is rendered on GUI 106 of user device 102 (see also, FIG. 10). In other embodiments, the price of building materials or the building price at 1006 is not hidden.

FIG. 10 illustrates an embodiment at 1000 of a GUI 106 displayed on a user device 102 that indicates a price of building materials, renders a view of a building design option menu, and renders a view of a 3D building model that has been modified to include selected building dimensions and/or selected building accessories. While the embodiment described in FIG. 10 is performed by system 114 and illustrated with respect to FIGS. 1-9 and 15, in other embodiments, the description and methods illustrated with respect to FIG. 10 can be used to generate and render any suitable GUI 106 displayed on a user device 102 to indicate a price of building materials, to render a view of a building design option menu and to render a view of a 3D building model that has been modified to include selected building dimensions and/or selected building accessories. In the illustrated embodiment, any suitable number of building design option menus or portions of a building design option menu may be rendered on the GUI 106 displayed on the user device 102. The building design option menus or portions of the building design option menus may be rendered in a nested format and may be selected or identified by the user via GUI 106 to be shown in full view on GUI 106. For example, the four building design option menus 1102, 1202, 1302 and 1402 illustrated in FIGS. 11-14 may be rendered in a nested format and selected or identified by the user via GUI 106 such that only one of the four building design option menus 1102, 1202, 1302 and 1402 is in full view on GUI 106.

In the illustrated embodiment, building design option menu 902 includes selected building dimensions that are identified or entered by the user into the information fields (e.g., 922′) for at least one of the one or more building dimension options 842 via the GUI 106 (illustrated at 1002) displayed on the user device 102. The “ 1/12 Roof Pitch” at 920 includes information field 922′ which represents information field 922 after selection by the user. Information field 922 as illustrated in FIG. 9 is shown after selection in FIG. 10 as information field 922′ and is filled in with a color (e.g., black). The “ 3/12 Roof Pitch” at 924 includes information field 926 which has not been selected by the user.

In the illustrated embodiment, the building design option menu 902 includes selected building accessories that are identified or entered by the user into the information fields (e.g., 906′, 910′ and 918′) for at least one of the one or more building accessory options 828 via the GUI 106 (illustrated at 1002) displayed on the user device 102. The “3′×7′ Frame Only Door” at 904 includes information field 906′ which represents information field 906 after selection by the user and is filled in with the color (e.g., black). The “2′ Overhang” at 908 includes information field 910′ which represents information field 910 after selection by the user and is filled in with the color (e.g., black). The “Wainscot Paneling” at 916 includes information field 918′ which represents information field 918 after selection by the user and is filled in with the color (e.g., black). The “3′ Overhang” at 912 includes information field 914 which has not been selected by the user. The building design option menu 902 also includes “Florida Alerts” at 928 and the “High Wind Alert” at 930.

In the illustrated embodiment, system 114, in response to receiving the selected building dimensions (922′) and the selected building accessories (e.g., 906′, 910′ and 918′), determines a price of building materials or building price at 1006 for the 3D building model at 1004 that has been modified to include the selected building dimensions (e.g., 922′) and the selected building accessories (e.g., 906′, 910′ and 918′) as illustrated in FIGS. 3-4. System 114 also utilizes selected building dimensions that include a width, length and height for the 3D building model illustrated at 1004 to determine the price of building materials or building price at 1006. In the embodiment illustrated in FIG. 10, the selected building dimensions include a width of 30 feet, a length of 40 feet, and a height of 12 feet (see also, FIG. 11). In other embodiments, any suitable width, length and height may be used. In other embodiments, the selected building dimensions may be specified using other units of measurement such as meters.

In the illustrated embodiment, system 114, in response to determining the price of building materials or building price at 1006, causes the GUI 106 displayed on the user device 102 to indicate the price of building materials or building price at 1006 and to render a view of the 3D building model at 1004 that has been modified to include the selected building dimensions (e.g., 922′) and the selected building accessories (e.g., 906′, 910′ and 918′). The selected building dimension 922′ is the “ 1/12 Roof Pitch” and is illustrated at 1014. The selected building accessory 906′ is the “3′×7′ Frame Only Door” and is illustrated at 1008. The selected building accessory 910′ is the “2′ Overhang” and is illustrated at 1010. The selected building accessory 918′ is the “Wainscot Paneling” and is illustrated at 1012.

In the embodiment illustrated in FIG. 10, the price of building materials or building price at 1006 is displayed. In other embodiments, because the building design load wind value 702 of 161 MPH illustrated in FIG. 7 is greater than the wind load limit 808 of 150 MPH for the “High Wind Alert” at 824 as illustrated in FIG. 8, the JavaScript content for the “High Wind Alert” at 824 is utilized by system 114 to hide the price of building materials or building price at 1006 on GUI 106 and the HTML content for the “High Wind Alert” at 824 may render text for a message that requests the user to call the manufacturer for a price.

FIG. 11 illustrates an embodiment at 1100 of a building design option menu 1102 rendered on a GUI 106 displayed on a user device 102. Building design option menu 1102 includes building dimension options that provide for identification or entry of building dimensions 1104 that includes entry of a width 1106 via information field 1108, entry of a length 1110 via information field 1112, and entry of a height 1114 via information field 1116. The building dimensions 1114 are identified or entered by the user into the information fields 1108, 1112 and 1116 via the GUI 106 displayed on the user device 102. In various embodiments, a keyboard and/or a touchscreen for a computer, laptop, tablet, phone or other suitable device can be used for entry of the width 1106 via information field 1108, entry of the length 1110 via information field 1112, and entry of the height 1114 via information field 1116. In the illustrated embodiment, the building dimensions 1104 are entered by the user into the information fields 1108, 1112 and 1116 in units of feet. In other embodiments, any suitable units of measurement can be used. Building design option menu 1102 includes building dimension options for a roof pitch 1118 that provides for identification or entry of a 1/12 roof pitch 1120 at 1122, a 1.5/12 roof pitch 1124 at 1126, and a 2/12 roof pitch 1128 at 1130. In other embodiments, building design option menu 1102 can include other suitable building dimension options.

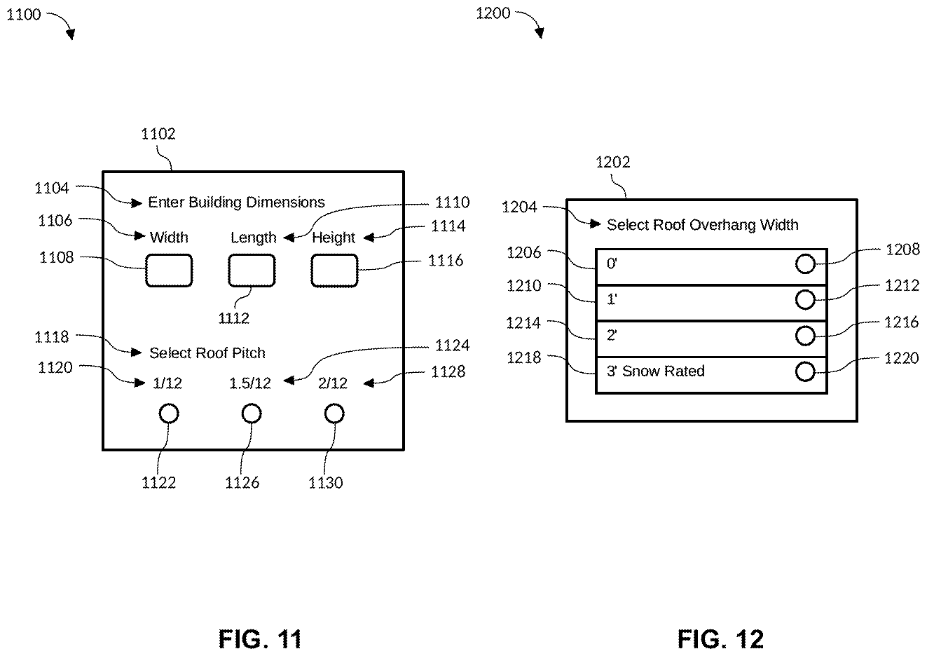

FIG. 12 illustrates an embodiment at 1200 of a building design option menu 1202 rendered on a GUI 106 displayed on a user device 102. Building design option menu 1202 includes building accessory options for a roof overhang width 1204 that provides for identification or entry of a “0′” overhang width 1206 at 1208, a “1′” overhang width 1210 at 1212, a “2′” overhang width 1214 at 1216 and a “3′ Snow Rated” overhang width 1218 at 1220. The roof overhang width 1204 options at 1206, 1210, 1214 and 1218 are specified in terms of feet. In other embodiments, any suitable units of measurement such as meters may be used. In other embodiments, building design option menu 1202 can include other suitable building accessory options.

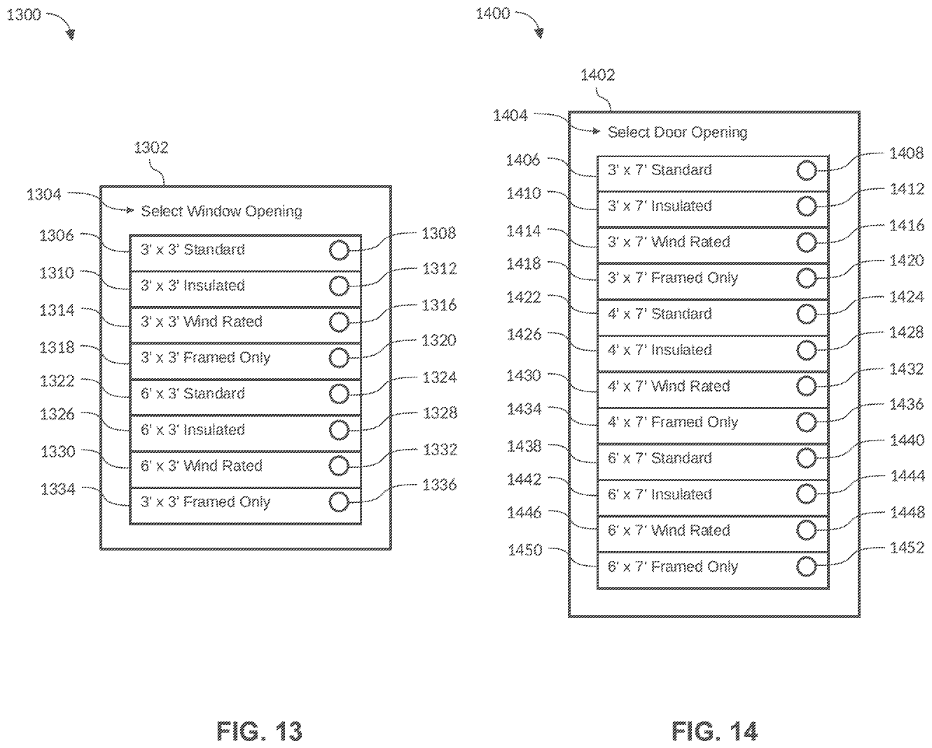

FIG. 13 illustrates an embodiment at 1300 of a building design option menu 1302 rendered on a GUI 106 displayed on a user device 102. Building design option menu 1302 includes building accessory options for a window opening 1304 that provides for identification or entry of a “3′×3′ Standard” window opening 1306 at 1308, a “3′×3′ Insulated” window opening 1310 at 1312, a “3′×3′ Wind Rated” window opening 1314 at 1316, a “3′×3′ Framed Only” window opening 1318 at 1320, a “6′×3′ Standard” window opening 1322 at 1324, a “6′×3′ Insulated” window opening 1326 at 1328, a “6′×3′ Wind Rated” window opening 1330 at 1332 and a “6′×3′ Framed Only” window opening 1334 at 1336. The window opening 1304 options at 1306, 1310, 1314, 1318, 1322, 1326, 1330 and 1334 are specified in terms of feet. In other embodiments, any suitable units of measurement such as meters may be used. In other embodiments, building design option menu 1302 can include other suitable building accessory options.

FIG. 14 illustrates an embodiment at 1400 of a building design option menu 1402 rendered on a GUI 106 displayed on a user device 102. Building design option menu 1402 includes building accessory options for a door opening 1404 that provides for identification or entry of a “3′×7′ Standard” door opening 1406 at 1408, a “3′×7′ Insulated” door opening 1410 at 1412, a “3′×7′ Wind Rated” door opening 1414 at 1416, a “3′×7′ Framed Only” door opening 1418 at 1420, a “4′×7′ Standard” door opening 1422 at 1424, a “4′×7′ Insulated” door opening 1426 at 1428, a “4′×7′ Wind Rated” door opening 1430 at 1432, a “4′×7′ Framed Only” door opening 1434 at 1436, a “6′×7′ Standard” door opening 1438 at 1440, a “6′×7′ Insulated” door opening 1442 at 1444, a “6′×7′ Wind Rated” door opening 1446 at 1448 and a “6′×7′ Framed Only” door opening 1450 at 1452. The door opening 1404 options at 1406, 1410, 1414, 1418, 1422, 1426, 1430, 1434, 1438, 1442, 1446 and 1450 are specified in terms of feet. In other embodiments, any suitable units of measurement such as meters may be used. In other embodiments, building design option menu 1402 can include other suitable building accessory options.

The detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIGS. 1 through 15. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A computer-implemented method, comprising:
generating, by one or more processors, design load values for a geographical location in response to receiving the geographical location via user identification or entry into a Graphical User Interface (GUI) displayed on a user device, wherein the design load values include a wind speed value, a snow load value, and/or a seismic value;
determining, by the one or more processors, option content to include in a building design option menu to be rendered on the GUI displayed on the user device, the building design option menu including information fields for each one of one or more building dimension options for a Three-Dimensional (3D) building model and for each one of one or more building accessory options for the 3D building model, the option content including the one or more building dimension options and/or the one or more building accessory options that meet or exceed the design load values;
determining, by the one or more processors, in response to receiving selected building dimensions that are identified or entered by the user into the information fields for at least one of the one or more building dimension options via the GUI displayed on the user device and/or in response to receiving selected building accessories that are identified or entered by the user into the information fields for at least one of the one or more building accessory options via the GUI displayed on the user device, a price of building materials for the 3D building model that has been modified to include the selected building dimensions and/or the selected building accessories; and
causing, by the one or more processors, in response to the generating of the price of the building materials, the GUI displayed on the user device to indicate the price of the building materials and to render a view of the 3D building model that has been modified to include the selected building dimensions and/or the selected building accessories.

2. The method of claim 1, wherein determining the price of the building materials comprises:
determining, by the one or more processors, a cost of the building materials for the 3D building model, wherein the 3D building model includes the selected building dimensions and/or the selected building accessories;
requesting, by the one or more processors, from a web-based mapping service, a factory travel distance between each one of one or more factories that supply the building materials and the geographical location;
determining, by the one or more processors, one of the one or more factories that has a smallest factory travel distance in response to receiving the factory travel distance between the one or more factories and the geographical location from the web-based mapping service; and
generating, by the one or more processors, the price of the building materials that is based on the cost of the building materials and a factory shipping fee for the building materials that is determined from a cost per unit distance factory fee and the smallest factory travel distance.

3. The method of claim 2, wherein determining the cost of the building materials comprises determining the cost of steel building materials for a prefabricated metal building.

4. The method of claim 2, wherein generating the price of the building materials further comprises saving the factory shipping fee in a memory on the user device, and wherein determining the price of the building material comprises:
determining, by the one or more processors, the cost of the building materials for the 3D building model, wherein the 3D building model includes the selected building dimensions and/or the selected building accessories;
requesting, by the one or more processors, from a user device, the factory shipping fee; and
generating, by the one or more processors, the price of the building materials that is based on the cost of the building materials and the factory shipping fee.

5. The method of claim 1, wherein determining the option content to include in the building design option menu to be rendered on the GUI displayed on the user device further comprises rendering the building design option menu that includes the option content on the GUI displayed on the user device.

6. The method of claim 1, wherein determining the option content to include in the building design option menu further comprises:
comparing, by the one or more processors, the design load values to load limits for each one of the building dimension options and/or building accessory options to determine the one or more building dimension options and/or building accessory options that, for each one of the design load values, either have no corresponding load limit or have the corresponding load limit that meets or exceeds the one of the design load values; and
rendering, on the GUI displayed on the user device, the building design option menu that includes the one or more building dimension options and/or the one or more building accessory options that either have no corresponding load limit or have the corresponding load limit that meets or exceeds the one of the design load values.

7. The method of claim 6, further comprising:
comparing, by the one or more processors, the design load values to load limits for alert message options to determine if any of the alert message options, for each one of the design load values, have a corresponding load limit that is less than and nearest to the one of the design load values; and
rendering, on the GUI displayed on the user device, any of the alert message options that have the corresponding load limit that is less than and nearest to the one of the design load values.

8. The method of claim 1, wherein generating the design load values for the geographical location further comprises generating geographical data in response to receiving the geographical location, wherein the geographical data includes one or more of a zip code, a city, a county, a state, a country, a specific pairing of latitude decimal degrees and longitude decimal degrees in a Cartesian coordinate grid or Global Positioning Satellite (GPS) coordinates.

9. The method of claim 8, further comprising:
comparing, by the one or more processors, the geographical data to location information for the alert message options to determine if any of the alert message options have corresponding location information that matches the geographical data; and
rendering, on the GUI displayed on the user device, any of the alert message options that have the corresponding location information that matches the geographical data.

10. The method of claim 1, further comprising:
receiving a payment request, via user identification or entry into the GUI displayed on the user device, for payment of the price of the building materials, wherein the payment request includes financial transaction information;
sending, by the one or more processors, the financial transaction information to a payment service for authentication in response to receiving the payment request; and
causing, by the one or more processors, the GUI displayed on the user device to indicate an acceptance of the payment request in response to the payment service authenticating the financial transaction information and processing the payment for the price of the building materials.

11. The method of claim 1, wherein determining the option content to include in the building design option menu comprises automatically determining the option content to include in the building design option menu each time a new geographical location that is different than the geographical location is received from the user device; and wherein determining the price of the building materials comprises automatically determining the price of the building materials each time the new geographical location that is different than the geographical location is received from the user device.

12. The method of claim 1, wherein determining the option content to include in the building design option menu to be rendered on the GUI displayed on the user device further comprises:
determining, by the one or more processors, a cost of the building materials for the 3D building model that is a preselected 3D building model;
requesting, by the one or more processors, from a web-based mapping service, a factory travel distance between each one of one or more factories that supply the building materials for the preselected 3D building model and the geographical location;
determining, by the one or more processors, one of the one or more factories that has a smallest factory travel distance in response to receiving the factory travel distance between the one or more factories and the geographical location from the web-based mapping service;
generating, by the one or more processors, the price of the building materials for the preselected 3D building model that is based on the cost of the building materials for the preselected 3D building model and a factory shipping fee for the building materials for the preselected 3D building model that is determined from a cost per unit distance factory fee and the smallest factory travel distance; and
causing, by the one or more processors, in response to the generating of the price of the building materials for the preselected 3D building model, the GUI displayed on the user device to include the price of the building materials for the preselected 3D building model, to render a view of the preselected 3D building model and to render the building design option menu that includes the option content.

13. The method of claim 1, wherein the geographical location received from the user device comprises a zip code, a residential or business address, a specific pairing of latitude decimal degrees and longitude decimal degrees in a Cartesian coordinate grid or Global Positioning Satellite (GPS) coordinates.

14. The method of claim 1, wherein determining the price of the building materials for the 3D building model further comprises automatically determining the price of the building materials for the 3D building model each time new selected building dimensions that are different than the selected building dimensions are identified or entered by the user into the information fields for the one or more building dimension options via the GUI for the user device and/or each time new selected building accessories that are different than the selected building accessories are identified or entered by the user into the information fields for the one or more building accessory options via the GUI for the user device; and wherein causing the GUI displayed on the user device to include the price of the building materials and to render the view of the 3D building model further comprises causing the GUI displayed on the user device to include the price of the building materials that has been modified to include the new selected building dimensions and/or the new selected building accessories and to render the view of the 3D building model that has been modified to include the new selected building dimensions and/or the new selected building accessories.

15. A computer program product embodied in a computer-readable storage device and comprising instructions that when executed by one or more processors, cause the one or more processors to:
generate design load values for a geographical location in response to receiving the geographical location via user identification or entry into a Graphical User Interface (GUI) displayed on a user device, wherein the design load values include a wind speed value, a snow load value, and/or a seismic value;
determine option content to include in a building design option menu to be rendered on the GUI displayed on the user device, the building design option menu including information fields for each one of one or more building dimension options for a Three-Dimensional (3D) building model and for each one of one or more building accessory options for the 3D building model, the option content including the one or more building dimension options and/or the one or more building accessory options that meet or exceed the design load values;
determine, in response to receiving selected building dimensions that are identified or entered by the user into the information fields for at least one of the one or more building dimension options via the GUI displayed on the user device and/or in response to receiving selected building accessories that are identified or entered by the user into the information fields for at least one of the one or more building accessory options via the GUI displayed on the user device, a price of building materials for the 3D building model that has been modified to include the selected building dimensions and/or the selected building accessories; and
cause, in response to the generating of the price of the building materials, the GUI displayed on the user device to indicate the price of the building materials and to render a view of the 3D building model that has been modified to include the selected building dimensions and/or the selected building accessories.

16. The computer program product of claim 15, wherein determining the price of the building materials comprises:
determining, by the one or more processors, a cost of the building materials for the 3D building model, wherein the 3D building model includes the selected building dimensions and/or the selected building accessories;
requesting, by the one or more processors, from a web-based mapping service, a factory travel distance between each one of one or more factories that supply the building materials and the geographical location;
determining, by the one or more processors, one of the one or more factories that has a smallest factory travel distance in response to receiving the factory travel distance between the one or more factories and the geographical location from the web-based mapping service; and
generating, by the one or more processors, the price of the building materials that is based on the cost of the building materials and a factory shipping fee for the building materials that is determined from a cost per unit distance factory fee and the smallest factory travel distance.

17. The computer program product of claim 15, wherein determining the option content to include in the building design option menu to be rendered on the GUI displayed on the user device further comprises rendering the building design option menu that includes the option content on the GUI displayed on the user device.

18. The computer program product of claim 14, further comprising:
receiving a payment request, via user identification or entry into the GUI displayed on the user device, for payment of the price of the building materials, wherein the payment request includes financial transaction information;
sending, by the one or more processors, the financial transaction information to a payment service for authentication in response to receiving the payment request; and
causing, by the one or more processors, the GUI displayed on the user device to indicate an acceptance of the payment request in response to the payment service authenticating the financial transaction information and processing the payment for the price of the building materials.

19. The computer program product of claim 14, wherein the geographical location received from the user device comprises a zip code, a residential or business address, a specific pairing of latitude decimal degrees and longitude decimal degrees in a Cartesian coordinate grid or Global Positioning Satellite (GPS) coordinates.

20. A system comprising:
one or more processors; and
one or more memory elements storing program instructions that when executed by the one or more processors cause the one or more processors to:
generate design load values for a geographical location in response to receiving the geographical location via user identification or entry into a Graphical User Interface (GUI) displayed on a user device, wherein the design load values include a wind speed value, a snow load value, and/or a seismic value;
determine option content to include in a building design option menu to be rendered on the GUI displayed on the user device, the building design option menu including information fields for each one of one or more building dimension options for a Three-Dimensional (3D) building model and for each one of one or more building accessory options for the 3D building model, the option content including the one or more building dimension options and/or the one or more building accessory options that meet or exceed the design load values;
determine, in response to receiving selected building dimensions that are identified or entered by the user into the information fields for at least one of the one or more building dimension options via the GUI displayed on the user device and/or in response to receiving selected building accessories that are identified or entered by the user into the information fields for at least one of the one or more building accessory options via the GUI displayed on the user device, a price of building materials for the 3D building model that has been modified to include the selected building dimensions and/or the selected building accessories; and
cause, in response to the generating of the price of the building materials, the GUI displayed on the user device to indicate the price of the building materials and to render a view of the 3D building model that has been modified to include the selected building dimensions and/or the selected building accessories.

21. The system of claim 20, wherein the one or more processors and one or more memory elements are located on the user device.

22. The system of claim 20, wherein the one or more processors and one or more memory elements are located within a cloud-based application service.
